(19) United States
(12) Patent Application Publication
(10) Pub. No.: US 2021/0279226 A1
(43) Pub. Date: Sep. 9, 2021

(54) SYSTEM AND METHOD FOR DETECTING VIOLATIONS OF SEGREGATION OF DUTIES IN SOFTWARE SYSTEMS

(71) Applicants: Jens Kettler, Frankfurt am Main (DE); Rodrigo Giner de la Vega, Frankfurt am Main (DE); Nicolas Hernandez, Frankfurt am Main (DE)

(72) Inventors: Jens Kettler, Frankfurt am Main (DE); Rodrigo Giner de la Vega, Frankfurt am Main (DE); Nicolas Hernandez, Frankfurt am Main (DE)

(21) Appl. No.: 16/729,536

(22) Filed: Dec. 30, 2019

(51) Int. Cl. G06F 16/23; G06F 16/248; G06F 21/62

(52) U.S. Cl. CPC G06F 16/2358; G06F 16/2365; G06F 2221/2141; G06F 21/6227; G06F 16/248

(57) ABSTRACT

The invention relates to a system and apparatus of segregation of duties as seen as a major class of control activities within a company's internal control framework. In recent years SOD controls in terms of user access rights has experienced a greater reliance of business processes on ERP systems. Internal control can be defined as a “a process, effected by an entity's board of directors, management and other personnel, designed to provide reasonable assurance regarding the achievement of objectives in the following categories: 1. Effectiveness and efficiency of operations. 2. Reliability of financial reporting. 3. Compliance with applicable laws and regulations”. This invention focuses on preventing any single employee from having complete control over all the phases i.e. authorization, custody and record keeping of the business transaction and avoiding a conflict of interest and prevent fraud.

### BACKGROUND OF INVENTION

### Field of Invention

The present invention in general relates to the software systems such as SAP® business suites (SAP® ERP, S/4HANA). In particular, the present invention deals with the implementation of segregation of certain activities to prevent fraud and error in software systems.

### Description of Prior Art

Background description includes information that may be useful in understanding the present invention. It is not an admission that any of the information provided herein is prior art or relevant to the presently claimed invention, or that any publication specifically or implicitly referenced in prior art.

Although modern ERP systems help companies becomes better organised, operating, administering but modifying an ERP system can be exceedingly complex. Enterprises face significant risk of intentional and unintentional insiders. Incidents caused by insiders may have devastating impact on an enterprise. Examples of insider frauds include stealing trade secrets, embezzling money, stealing customer identities, disclosing customer information and engaging in risky trading in the name of enterprise. As employees join and leave a business organization, or get promoted or given new assignments within an organization, the organization's ERP system must be continually updated to provide those employees with the necessary authorizations to perform their assigned tasks, and to delete those authorizations that are no longer needed. Over the time, the originally well designed internal controls implemented by a system can become outdated, creating new opportunities for fraud and abuse. Therefore, as people join and leave and move about within a company, it is important that companies routinely carry out SOD (Segregation of Duties) analysis to ensure that their internal control mechanisms are well maintained.

Furthermore, as a business grows into new areas, or as previously unanticipated abuses or internal control failures are discovered, businesses need to continually revise and refine their internal controls and develop new SOD mechanisms to prevent further technical failures. As a company's internal controls grow more sophisticated and complex, the task of undertaking an SOD analysis grows exponentially more complex. Standard methodologies for performing SOD analysis are tedious, cumbersome, and inadequate.

The Sorbanes-Oxley Act of 2002 (Sox Act, 2002), codifies a framework for internal accounting controls. The risk from insufficient segregation of duties is one risk that is included in these accounting controls. If certain duties are concentrated on a single person, the chance of employee's error or malfeasance going undetected is greatly increased. For example, if an employee can create a supplier in an accounts payable system and also authorize an invoice from that supplier for payment, a risk exists that the employee could create and initiate payments to a fake supplier to steal company's funds. In an enterprise, there are numerous duties or functions referred to generally as incompatible functions that should not be performed by the same employee.

United States Application US20050209899 to King et al. (2005) pertains to an audit system which further comprises a set of business processes libraries having plurality of business process incompatibilities. Additional business functions can be added to the registry by auditors to suit the specific needs of an enterprise. A report generator determines the business functions available to each employee and compares these functions with the registry to ensure that proper segregation of duties is observed. On the other hand, U.S. Pat. No. 8,868,728 to Margolies et al. (2014), describes a system, method and apparatus including computer programs encoded on computer storage media, for detecting insider fraud. Another U.S. Pat. No. US8402547 to Wiegenstein (2013) pertains to a static code analysis tool (SCA), apparatus and method detects, prioritizes and fixes security defects and compliance violations in SAP® ABAP™ code.

U.S. Pat. No. 7,941,336 to Robin January (2011) describes a method and user interface for performing and displaying a segregation of duties analysis on an enterprise resource planning system or back office software system displays potential segregation of duty violations. Yet another U.S. Pat. No. US7752562 to Mohanty et al. (2010) pertains to a method which includes retrieving a plurality of data extractors to extract data across a plurality of business applications

After thorough study of the aforementioned documents and more related ones, there is a dire need to develop and design a methodology that would address one or more drawbacks or insufficiencies in such systems and methods, thereby limiting their practical applications. The abovementioned problems may be duly sorted with the development of a cost effective mechanisms that reduce the time, efforts and complexities in defining potential SOD conflicts as well as monitoring, reporting and reducing potential SOD conflicts. Any SOD conflicts which are found are then stored and may be reported on.

### SUMMARY OF INVENTION

The present disclosure in general relates to the software systems such as SAP® business suites (SAP® ERP). In particular, the present disclosure deals with the implementation of segregation of certain activities to prevent fraud and error in SAP® business software systems. The present disclosure also pertains to the methods of performing the segregation of duties in SAP® ERP system.

One of the preferred embodiments of the present invention is to provide users with a methodology to successfully detect the SOD conflict in SAP® ERP systems. The SOD conflict may be easily detected as the present invention provides with a mechanism to analyse the historical data regarding the transactions that happened in the past. A patch is added to the existing SAP® system and it is written in the same language as SAP® business suites. In the present invention, SOD violation is detected in near real time.

Another embodiment of the present invention describes the working of software for detecting the violation of segregation of duties in SAP® ERP system. The software uses SAP®'s change logs called Change Documents (CDs) that log changes to the business data in the SAP® ERP system. SAP® ERP standard software has many CDs, and customers can also create additional, new CDs. But CDs for different SAP® objects cannot be easily correlated: each CD has a unique identifier for the type of SAP® object in concern, but different identifiers for different SAP® objects cannot be linked by using only this much of information.

Further embodiments of the present disclosure deals with providing a cost effective, easily manageable and real time tracking system for Segregation of duties violation in a SAP® ERP business suite. The embodiments of the present invention disclosed herein are not to be construed as limitations. All the embodiments and illustrations will further be evident with the help of detailed discussion and attached drawings.

### BRIEF DESCRIPTION OF THE DRAWINGS

FIG. 1 illustrates a Relational Database Design;

FIG. 2 illustrates a flowchart detecting SOD conflicts for objects;

FIG. 3 illustrates

FIG. 4 represents an embodiment of the present invention comprising user terminal coupled with web application server;

FIG. 5 represents an embodiment of the present invention wherein the system retrieves data from SAP® ERP database;

FIG. 6 represents an embodiment wherein a conflict scan is executed in order to analyse segregation of duties (SOD) conflict;

FIG. 7 illustrates data violation management setup with authorization objects;

FIG. 8 represents a screenshot of the present invention showing alerts monitoring.

### DETAILED DESCRIPTION OF PREFERRED EMBODIMENTS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

As defined herein, a “Table” refers to a SAP® Table using which one can display the change documents (CDs) related to it. A table can contain one or more fields, each defined with its data type and length. The large amount of data stored in a table is distributed amongst the several fields defined in the table. The table represents the Database where data actually resides. As discussed in the present disclosure, “Object” is a programming language that allows developers to create and run applications that contain program objects. As used in the present disclosure, “Change documents” refers to the changes in any of the objects of SAP®. These Change Documents contain all the relevant information like the changed object dataset, old and new values, date and time of change logs along with the user's name that has made the changes.

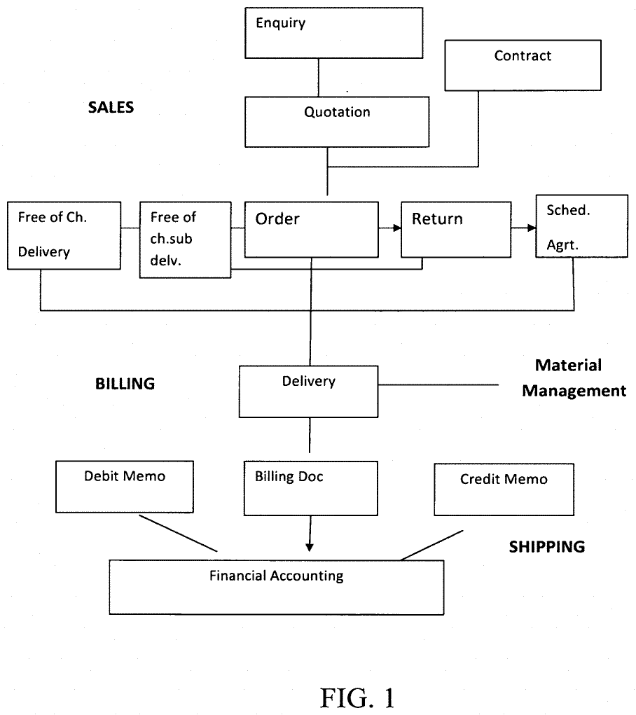

Two actions are considered to be in conflict if a single user is assigned to execute the same business critical applications. Conflicting actions could lead to fraudulent business activities. Avoiding fraud is the ultimate goal of SOD analysis addressed by the present invention. In the RDBMS design as described in FIG. 1 an enterprise system stores data in a database(s) in various formats and structures. The design of a databases is from an enterprise (business) perspective which implies that generally the dataflow in FIG. 1, to a business process is tracked and the table relationships coincide with the business processes i.e. sales, billing and shipping and accounting as seen in FIG. 1. The drawback with the RDBMS design in FIG. 1 is that it only provides partial visibility from an IT audit and security point of view, which means SOD conflicts, can be missed and potential SOD conflicts (fraud, security breaches and regulatory compliance) cannot be catered easily

Moreover, SOD conflicts inherently exist in these types of traditional RDBMS database designs as seen in FIG. 1 and since these relations are not defined, it becomes difficult to manage these SOD conflicts. The companies already using SAP® business suites can make concatenations. Information can be taken from tables in their databases in order to read SOD matrices being used by third party systems. To be able to do this, the third party access control product used must be identified. One of the preferred embodiments of the present invention relates to the concatenations/integrations/combination/incorporation in pre-existing SAP® business suites of companies.

The present invention aims at nullifying the SOD conflicts. For example, if Table1 stores data upon which and when a vendor data was changed and Table2 stores data containing vendor payments details which includes data of user, vendor and associated amounts. From a database design perspective there is no link between Table1 and Table2. However, an inherent relationship exists in that the same user changed a vendor and made a payment to that vendor. The SOD rules are often represented in the form of a matrices where critical combinations of steps are marked and authorizations for both the steps shall not be granted to the single user. For example, in procurement, a critical combination of activities is:

13) Creating a vendor in a software system, and
14) Entering an invoice to be paid to the same vendor.

In this example, the maintenance of vendor's master data, and entering outstanding invoices from vendors shall be separated. This is for the same vendor, i.e. a user should not maintain master data for vendor X and also enter invoices for the same vendor. But it is allowed to maintain master data for vendor X and entering invoices for a different vendor Y, as for each procurement process, there would be appropriate control by ensuring the segregation of duties.

According to yet another embodiment of present invention, the said system and method facilitates user management in SAP® ERP system. The present invention aims at adequate user management i.e. One user administrator creating other users in the said software system must not be able to additionally assign authorizations to the new users, or to change authorization roles. Systems such as SAP® ERP allow enforcement of SOD rules by defining and assigning authorization rules that fulfil a given SOD matrix. It is also possible here to take into account organizational structures, so that the user can have authorizations for steps, but not for the same objects, effectively again providing the segregation of duties. The definition of such authorization concepts is a standard and supported by many tools available in the market.

Organizations using computer systems such as SAP® run costly projects and processes to ensure that computer system security is provided for by such SOD rules, but it is impossible in most cases to ensure a complete SOD is enforced. This is due to the fact that there are many critical combinations that an authorization system fulfilling all SOD requirements will be very granular and thus also requires many users to work on small, separated steps. This is extremely costly and organisations cannot implement a fully compliant system due to cost reasons (and also because of faulty implementations of authorization concepts, or weak or non-existing change management processes so that in the maintenance phase of an authorization concept SOD conflicts are introduced). This means that after implementing an authorization concept, a number of SOD rules are not fulfilled and the organisation is still at a risk of existing/remaining SOD conflicts in the authorization concept that can be misused for fraudulent transactions, and there is also a higher likelihood of errors as the important review functions are not listed.

SOD conflicts in authorizations are a risk, and therefore the execution of risky combinations of transactions in the computer systems should be monitored as a compensating control (for lacking preventive control of effective SOD enforcements at the authorization level). The monitoring has to take into account: a) Executive types of transactions, 2. Organizational/Object-level details to check whether the same object was changed (e.g. whether the invoice is from the same vendor; an analysis whether a vendor was maintained, “an invoice was entered). All these are not efficient as it will create many false positives.

According to yet another embodiment of present invention, the said system and method aids in mapping of data from Change Documents (CDs). One of the embodiments of the present invention describes the integrated software which uses SAP®'s change logs called Change Documents (CDs) that record changes to business objects in the SAP® ERP. SAP® standard software has many Change Documents, and customers can create additional and new Change Documents (CDs).

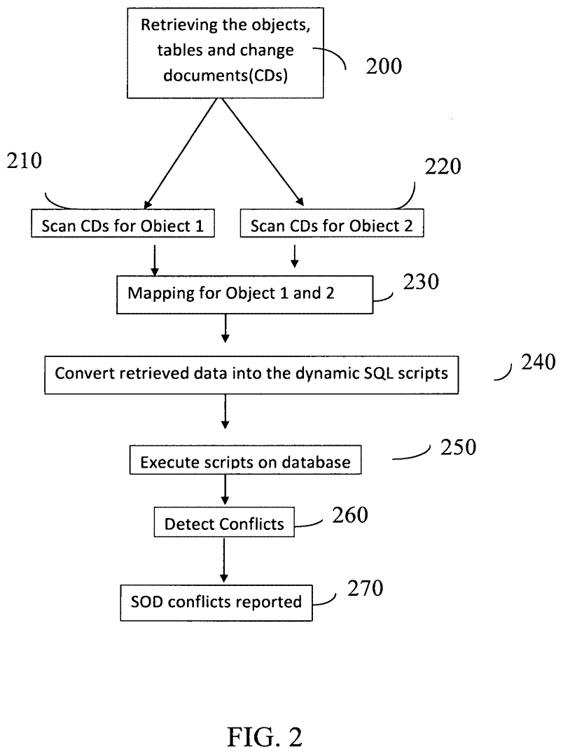

Generally SOD rules work on SAP® object level. For example, the vendor master is a SAP® object, and an invoice (financial document) is another SAP® object. But CDs for different SAP® objects cannot be easily correlated. Each CD (Change Document) has a unique identifier for the type of concerned SAP® object, but different identifiers for different SAP® objects cannot be linked by using just this information. For example, the CD (Change Document) for vendor master has the vendor number and the CD for invoice has the invoice number. There is no way to determine whether a certain invoice comes from defined vendor just by looking at invoice/vendor numbers. Invoice and vendor numbers, or in general: the identifiers for CD1 and CD2, have to be matched. In FIG. 2, in order to detect SOD conflicts for SAP® objects 1 and 2, the present invention scan CDs for changes to object 1, look up a table that has mapping for objects 1 and, retrieve the corresponding identifier for object 2, and then scan the CD list again for identifier for type 2 and then compare the username i.e. the user who made the change to object 1 and 2. If the username is the same, the present system has found a SOD conflict. The above mentioned details are better represented in a flowchart in FIG. 2 wherein the SAP® objects, tables and change documents are retrieved at step 200. The CDs for object 1 is scanned at step 210 and the CDs for object 2 is scanned at step 220. This is further followed with the mapping of objects 1 and 2 at step 230. The converted data is further retrieved into dynamic SQL scripts at step 240 and the said system execute the database scripts at step 250. The results of the query determinate if a conflict was found at step 260 followed with the reporting of SOD conflict at step 270.

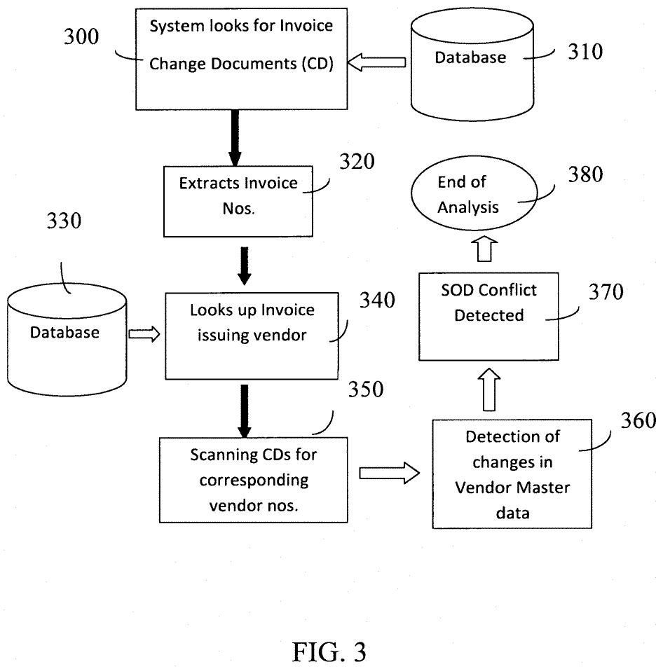

The present invention utilizes data from other SAP® tables to provide for the mapping. In FIG. 3, the SAP® table with full data for an invoice has the vendor number, so when the present system looks at the invoice CDs from database 310 at step 300, it further extracts the invoice numbers at step 320 followed with the look up of the corresponding invoice issuing vendors from database 330 in another SAP® table at step 340. This is further followed with scanning CDs for that vendor number at step 350 in order to detect changes to that vendor master data at step 360. In case the vendor master data is changed, an SOD conflict is reported at step 370 leading to end of analysis at step 380.

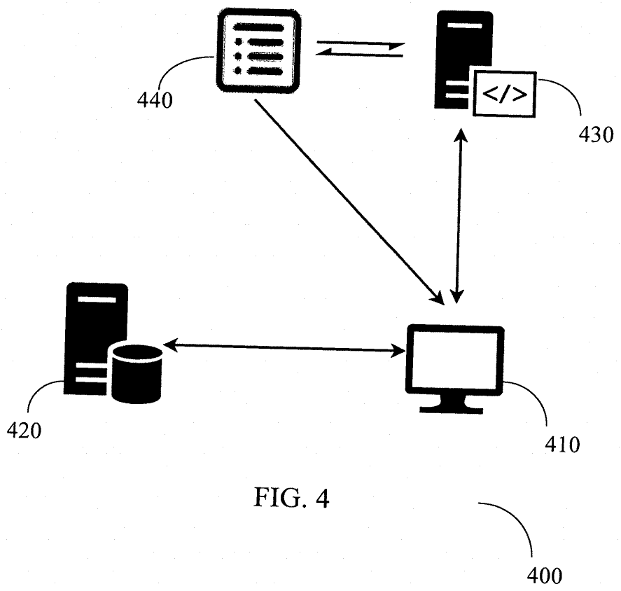

FIG. 4 represents an embodiment 400 of the present invention comprising user terminal 410 communicatively coupled with the web application server 430. The user terminal is configured to access Enterprise Resource Planning (ERP) database from the database server 420. The present invention is executing a set of instructions on the web application server 430 in order to detect change logs called Change Documents (CD) at 440. Change Documents 440 (CD) presents log changes to the business data in the enterprise resource planning system.

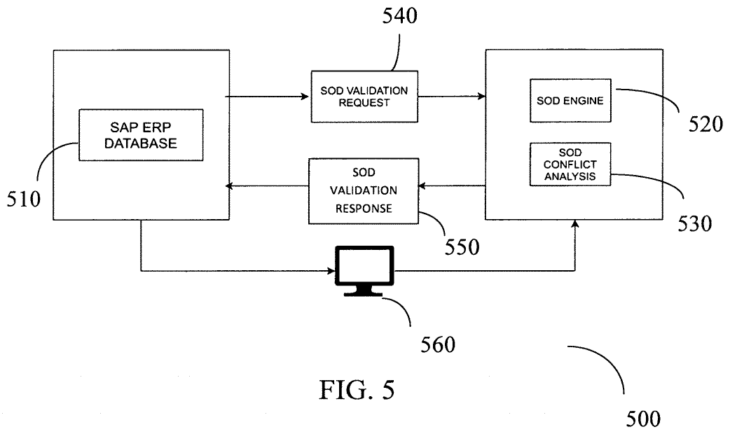

FIG. 5 illustrates an embodiment 500 of the present invention wherein the system retrieves data from SAP® ERP database 510 in order to initiate SOD validation request 540. The request is executed by the SOD engine 520 in order to detect and analyse SOD conflict at 530. After the detection of SOD conflict at 530, a response 550 for SOD validation is further sent to the SAP® ERP database. Finally, the SOD conflict is displayed at the user terminal 560.

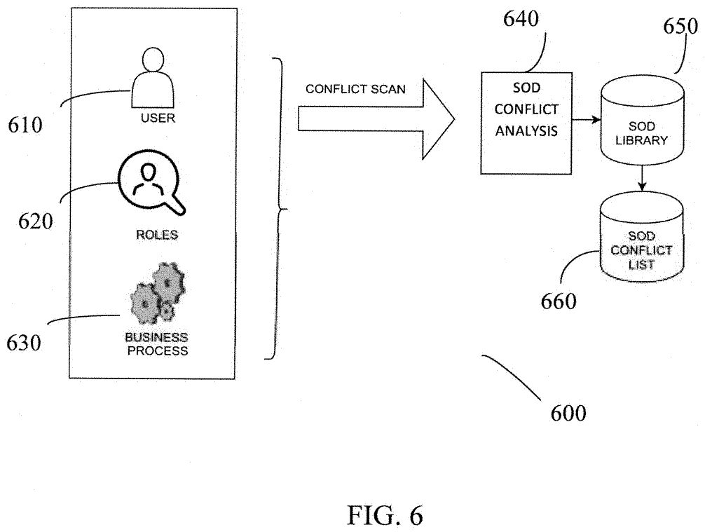

FIG. 6 illustrates embodiment 600 wherein business entities like user 610, business roles 620 and business processes 630 undergoes conflict scan in order to analyse segregation of duties (SOD) conflict at 640. The SOD library database 650 stores the segregation of duties analysis. Finally, the SOD conflict list is further stored in database 660.

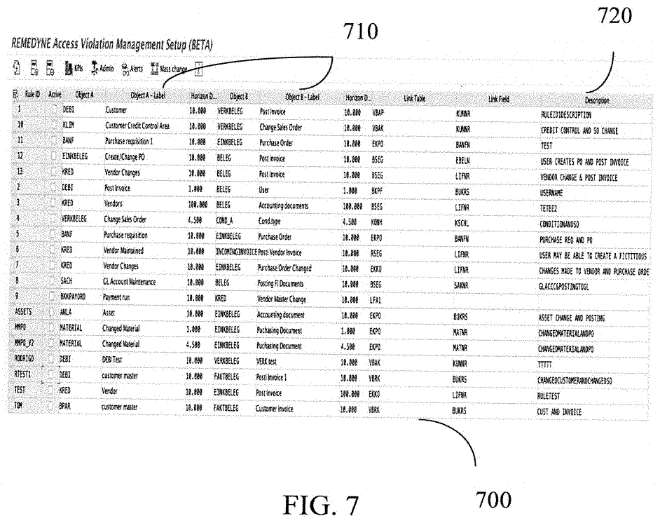

FIG. 7 illustrates screenshot 700 of the present invention showing data violation management setup with authorization objects 710 and their respective descriptions at 720. The authorization objects determine type of access to be assigned to the users.

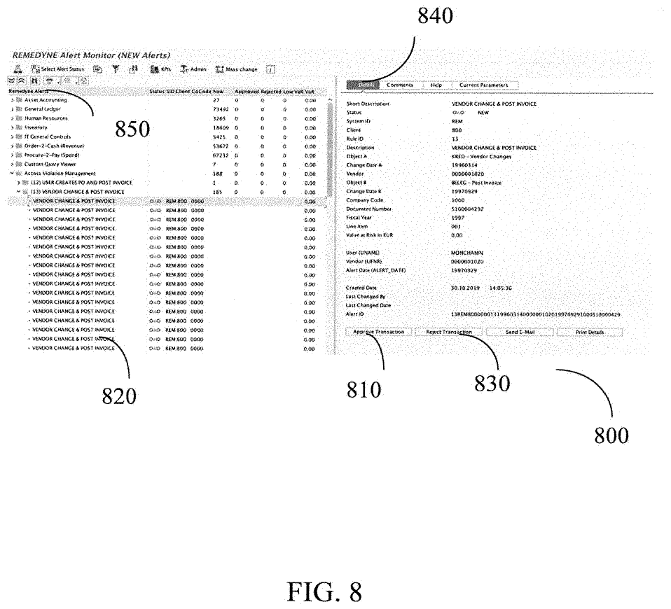

FIG. 8 illustrates screenshot 800 of the present invention showing alerts monitoring at 850. The change logs (Change Documents CD) 820 shows changes to the business data. The details 840 of the change logs can be access by the administrator. The administrator further approves transactions 810 and reject transaction 830.

While a number of preferred embodiments have been described, it will be appreciated by persons skilled in the art that numerous variations and/or modifications may be made to the invention without departing from the spirit or scope of the invention as broadly described. The present embodiments are, therefore, to be considered in all respects as illustrative and not restrictive.

1) A system for detecting violations of Segregation Of Duties (SOD) comprising a web application server configured to:
a. identify and analyse the historical data regarding the transactions associated with a plurality of users;
b. accessing change documents of a plurality of objects that log transactions to the business data in the said system;
c. converting the change documents of a plurality of objects into dynamic SQL (Structured Query Language) database scripts;
d. execute the database scripts and detect SOD (Segregation of Duties) conflicts;
e. report the conflicts to the end user.

2) A computer implemented method for detecting violations of Segregation Of Duties (SOD) in software enterprise systems comprising:
a. identify and analyse the historical data regarding the transactions associated with a plurality of users;
b. accessing change documents of a plurality of objects that log transactions to the business data in the said system;
c. converting the change documents of a plurality of objects into dynamic SQL (Structured Query Language) database scripts;
d. execute the database scripts and detect SOD (Segregation of Duties) conflicts;
e. report the conflicts to the end user.

3) A computer implemented method according to claim 2, wherein the system forbids existing users apart from the administrator to assign additional authorisations to new users or change authorization roles.

4) A computer implemented method that facilitates user management in the software enterprise system comprising the steps of:
a. identifying authorization objects associated with the business processes;
b. identifying fields associated with the authorization objects;
c. the authorization objects determine type of access to be assigned to the users;
d. using check boxes to identify a particular business area, process, authorization object and field to execute Segregation Of Duties (SOD) analysis;
e. executing instructions and display Segregation Of Duties (SOD) analysis data to the end user.

5) A system according to claim 1, wherein the said system identifies security system entities of the enterprise resource planning system (e.g., profiles, roles, users of the business process).

6) A system according to claim 5, wherein the security system entities having overlapping and non-overlapping authorizations perform the steps of the organizational function aiding in mapping of data from Change Documents (CD).

7) A system according to claim 6, wherein the organization represents the structure of an enterprise resource planning system.

8) A system according to claim 6 wherein authorization means restricting the users to access certain levels of business processes or business entities in the enterprise resource planning system.

9) A system according to claim 6 wherein Change Documents (CD) log changes to the business data in the enterprise resource planning system.

10) A system according to claim 9, wherein the Change Documents (CD) contain all the relevant information like the changed object dataset, old and new values, date and time of change logs along with the user's credentials who made the changes.

11) A system according to claim 1, wherein the segregation of duties (SOD) violation is tracked and managed in real time.

12) A computer implemented method for detecting violations of segregations of duties according to claim 4 comprising the steps of:
a. scanning Change Documents (CD) for changes in the authorization objects;
b. look up to a table that has mapping for the said objects;
c. retrieve corresponding identifies for the said objects;
d. comparing Change Documents (CD) for changes in the authorization objects;
e. detecting the Segregation Of Duties (SOD) conflicts.
